(19) United States
(12) Patent Application Publication
(10) Pub. No.: US 2004/0133428 A1
(43) Pub. Date: Jul. 8, 2004

(54) Dynamic control of resource usage in a multimodal system

(76) Inventors: Paul St. John Brittan, Claverham (GB); Alistair Neil Coles, Bath (GB)

Correspondence Address: HEWLETT-PACKARD COMPANY, Intellectual Property Administration, P.O. Box 272400, Fort Collins, CO, 80527-2400, US

(21) Appl. No.: 10/607,577

(22) Filed: Jun. 25, 2003

(30) Foreign Application Priority Data
Jun. 28, 2002 (GB) 0215118.1

(51) Int. Cl. G10L 11/00

(52) U.S. Cl. 704/276

(57) ABSTRACT

The relative average actual or allocated usage of a limited resource, such as communication bandwidth, by task entities in different respective input-modality processing stacks is dynamically adjusted. This adjustment is effected by a moderator in dependence on one or more of the actual usage of the different modalities by a user, the confidence in the results of processing of each of the modalities, and pragmatic information on mode usage.

### FIELD OF THE INVENTION

The present invention relates to dynamic control of resource usage in a multimodal system.

### BACKGROUND OF THE INVENTION

Multimodal systems are systems which permit a user to provide input in different modalities, such as speech or gesture, in parallel, in sequence or as alternatives. The processing of an input modality is typically split up into a number of tasks carried out by corresponding functionality, herein referred to as task entities. The chain of task entities involved in processing an input modality form a processing stack for that modality. The results of processing of input via one modality can be combined or ‘fused’ with the results obtained from the processing of other modalities at any stage in the processing chain and is not restricted to being combined by the application to which the inputs are directed. Typically, the higher processing stages of a multimodal input system will be carried out by a task entity or entities shared across all modalities, each such shared task entity being logically part of the processing stack of each modality.

The processing demands for processing modalities such as speech can be very high if, for example, a large vocabulary is to be catered for and this has restricted the adoption of modalities such as speech as input interfaces for mobile devices which typically have very limited processing power and memory available. However, advances in wireless communication, ad hoc networks and human language technologies are set to enable mobile devices to offload processing tasks requiring specialized or powerful processing resources to infrastructure-based task entities. FIG. 1 of the accompanying drawings illustrates a multimodal input system for a mobile device in which the symbolic recognition and syntactic analysis tasks involved in processing speech and gesture modalities are carried out by remote task entities 12, 13 and 22, 23. As can be seen, the feature-extraction task entities 11, 21 of the mobile device receive inputs from speech and gesture sensors 10 and 20 respectively and pass their outputs to the remote symbolic-recognition task entities 12, 22 over a communication channel 40; similarly, the outputs of the remote syntactic-analysis task entities 13, 23 are passed to semantic-analysis task entities 14, 24 of the mobile device over the same or another communication channel 40/41. The semantic task entities 14, 24 provide inputs to common higher-level task entities 30-32 that respectively provide pragmatic processing, dialogue management, and the application or service itself. The setting up of the ad hoc organization of local and remote task entities is effected by a modality manager 50 of the mobile device.

Real-time utilization of off-device task entities opens up the possibility that in the near future mobile device users will be able to use a plethora of interaction modalities such as speech, gesture recognition, etc. Users will also expect that their appliances will be able to to interact seamlessly, providing a multimodal user interface onto services and information regardless of the communication technology used by the device (for example, technologies such as 3G cellular, 802.11 wireless LAN, and Bluetooth).

In a world of disaggregated computing, the bandwidth between input clients (such as, but not limited to, mobile devices) and computing resources serving as task entities will dramatically influence where and to what degree multimodal input (with or without fusion) can be carried out effectively. At certain points in the communications infrastructure used by the input clients, bandwidth is likely to be less than needed. For example, where a mobile device has a collection of co-operating input clients that utilise internet-based task entities via an 802.11 network to process multiple input modalities, the bandwidth of the interconnection between the mobile device and the task entities will be influenced by other users in the local vicinity and the environment. A fall in the available bandwidth will impact all modalities currently being handled.

It is an object of the present invention to facilitate multimodal input in systems subject to resource restrictions.

### SUMMARY OF THE INVENTION

According to one aspect of the present invention, there is provided a method of dynamically controlling usage of a resource by task entities respectively involved in processing different input modalities, wherein the relative average actual or allocated usage of the resource by the task entities is dynamically adjusted according to one or more of the following:

actual usage of the different modalities by a user;

confidence in the results of processing of each of the modalities;

pragmatic information on mode usage.

Pragmatic information on mode usage provides a measure of how the target application is set up to use input from different modes—in other words, whether input from one modality is more important or useful than that from another modality, at least in the current application context.

The resource concerned is, for example, communication bandwidth or processing power.

According to another aspect of the present invention, there is provided an arrangement comprising task entities respectively involved in processing different input modalities, a limited resource arranged to be used by the task entities, and a moderator for dynamically adjusting the relative average actual or allocated usage of the resource by the task entities in dependence on one or more of the following:

actual usage of the different modalities by a user;

confidence in the results of processing of each of the modalities;

pragmatic information on mode usage.

### BRIEF DESCRIPTION OF THE DRAWINGS

Embodiments of the invention will now be described, by way of non-limiting example, with reference to the accompanying diagrammatic drawings, in which:

FIG. 1 is a diagram, already described above, of a mobile device with two input modalities where certain processing tasks in respect of those modalities are carried out on remote resources;

FIG. 2 is a diagram illustrating the control of the relative usage of communication bandwidth by task entities associated with different input modalities;

FIG. 3 is a diagram similar to FIG. 1 but showing bandwidth usage control for two communication channels between the mobile device and the remote resources; and

FIG. 4 is a diagram similar to FIG. 3 but for the case of only a single communication channel existing between the mobile device and the remote resources.

### BEST MODE OF CARRYING OUT THE INVENTION

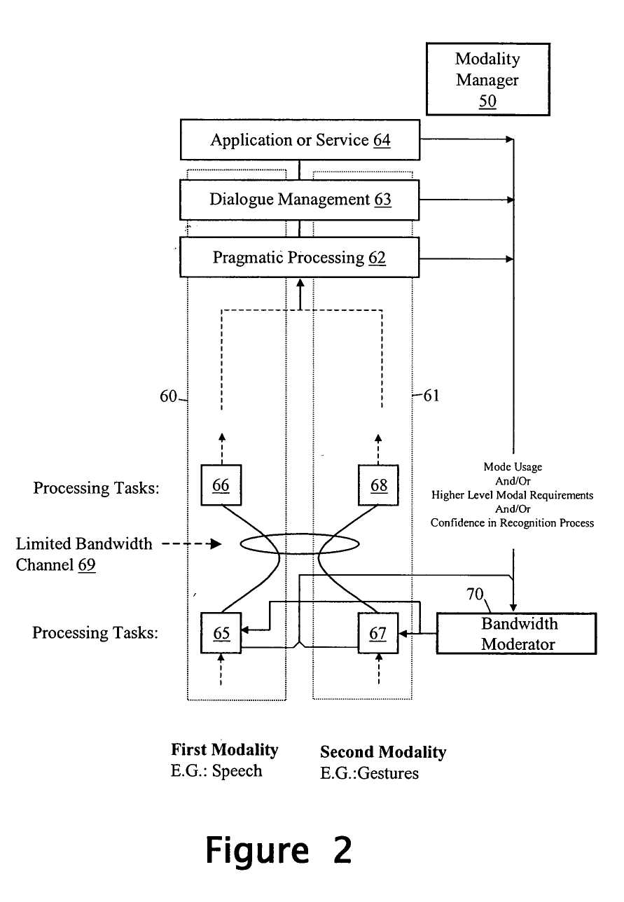

FIG. 2 illustrates a generalized example embodiment of the present invention in which task entities have been organized by a modality manager 50 to provide viable processing stacks 60, 61 for first and second input modalities. The stacks 60, 61 feed an application or service 64 and include common, higher-level, task entities 62 and 63 that respectively provide pragmatic processing and dialogue management. The processing stack 60, 61 of each input modality also includes a respective pair of task entities 65, 66 and 67, 68 with the entities in each pair being linked via a bandwidth-limited communication channel 69 that is common to both modalities. Bandwidth restrictions on the communication channel linking the task entities of the two task-entity pairs thus have the potential of affecting processing of both modalities.

However, in the FIG. 2 arrangement a bandwidth moderator 70 is provided to control the relative usage of the communication channel 69 by the task entities of the two modalities. The bandwidth moderator 70 receives inputs regarding input mode usage by the user, the modal requirements of the dialogue manager and application, and confidence in the recognition process for each modality (see arrow 71). The first of these inputs can be derived from any modality-specific processing stage in the processing stacks 60, 61 though generally the input will be derived at the stage controlled by the bandwidth moderator 70; the second input comes from the application and/or dialogue and/or pragmatic manager entities 62, 63, 64; and the third input can be an overall confidence measure from the application and/or dialogue and/or pragmatic manager top-level 62, 63, 64 or a more local confidence measure either from one or both task entities 65, 67 controlled by the bandwidth moderator or from one or both task entities 66, 68 receiving the output from an entity controlled by the bandwidth moderator 70. By way of example of a locally-derived third input, a syntactic-analysis task entity may monitor its own performance and if it is not confident that the correct sentence is represented in the word or phoneme lattice, then it indicates this to the associated bandwidth moderator 70 with a view to getting increased bandwidth to represent sentences. An example of confidence scoring in a speech recognizer is described in “Recognition Confidence Scoring for Use in Speech understanding Systems”, T J Hazen, T Buraniak, J Polifroni, and S Seneff, Proc. ISCA Tutorial and Research Workshop: ASR2000, Paris, France, September 2000.

Whilst all three inputs are preferably provided to the bandwidth moderator 70, it is possible for the moderator to operate using just any two or any one of the inputs. Additional inputs may also be provided to the bandwidth moderator.

The bandwidth moderator 70 uses the inputs it receives to determine a target relative usage of the channel bandwidth of channel 69 by the two modalities in order to seek to optimize overall input performance. For example:

if a person is only using speech, when both speech and gesture modalities are available, then the bandwidth moderator 70 determines that a reduction in usage of the bandwidth resource by the gesture modality is appropriate;

if speech recognition is found to be poor (a low confidence score is measured) the moderator 70 may determine that it is appropriate to increase the data generated in the lower speech-modality task entities and allocate more bandwidth for passing on this data as this may well result in overall input performance gains outweighing any loss in gesture recognition capability resulting from the reduced data flow in the gesture modality processing stack.

In the present embodiment, control of the relative usage of the limited bandwidth of the channel 69 by the two modalities is effected by the moderator 70 controlling the amount of data output by the task entities 65, 67 that use the channel 69. How this is done depends on the type of task being carried out by each entity. For example, where the task entities concerned are sensors, the sampling rates of the sensors can be changed relative to each other to favour one modality over the other as required by the bandwidth moderator. If the task entities being controlled effect feature extraction then the bandwidth moderator 70 can be arranged to control the number of features extracted for each modality. Similarly, if the task entities controlled by the bandwidth moderator effect syntactic and semantic analysis, then the depth and breath of the word or phoneme lattices can be controlled.

Whilst generally the task entities 65, 67 using the communications channel 69 will be at the same level in the processing stacks 60, 61 of each modality, this is not necessarily the case as the moderator 70 can be arranged to understand how to control different types of task entity to effect the desired bandwidth relative usage control. Furthermore, it will be appreciated that the bandwidth moderator 70 can be arranged to control the relative usage of the limited communication bandwidth by more than two modalities. Again, whilst the resource controlled by the moderator 70 in the FIG. 2 example is channel bandwidth, the moderator can be used to control the relative usage by the input modalities of other limited resources such as processing power and/or memory.

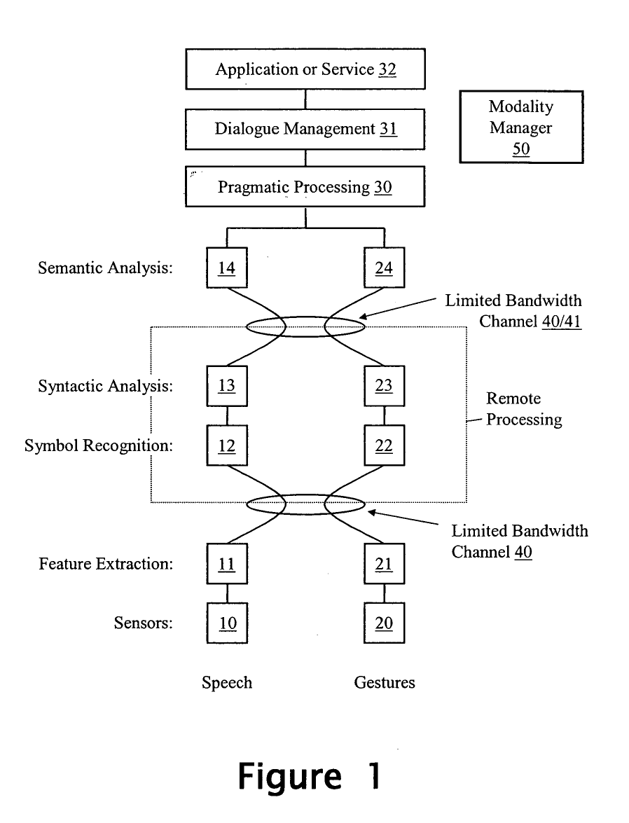

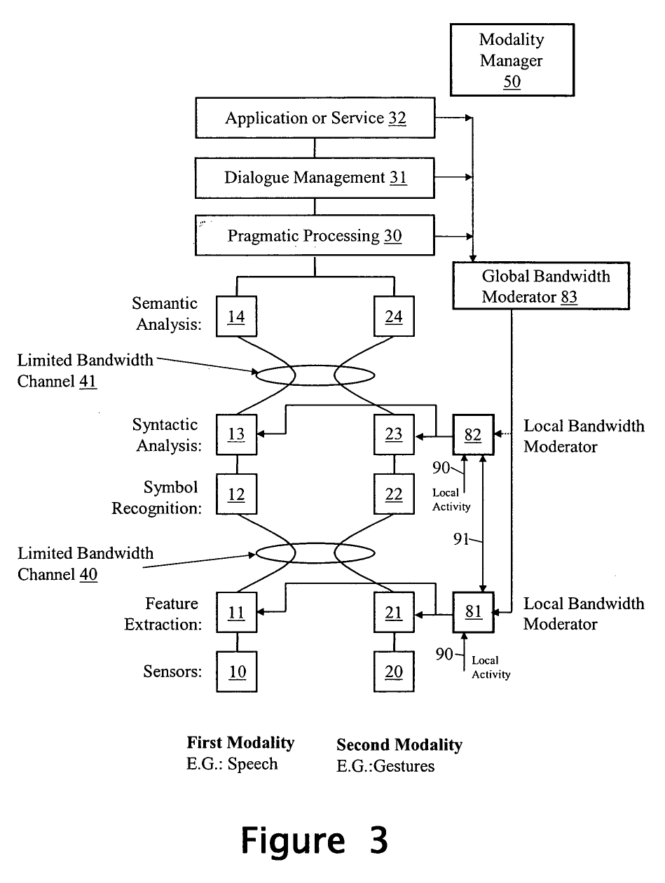

FIG. 3 illustrates an arrangement in which the feature-extraction task entities 11, 21 of two modalities share a first communication channel 40 to respective symbol-recognition task entities 12, 22, and the syntactic-analysis task entities 13, 23 of these modalities share a second communication channel 41, distinct from channel 40, to respective semantic-analysis task entities 14, 24. FIG. 3 is, for example, applicable to the arrangement of FIG. 1 where the two input modalities are speech and gesture; accordingly, in FIG. 3 the task entities are referenced with the same reference numerals as in FIG. 1, notwithstanding that the FIG. 3 arrangement can equally be applied to other input modalities.

The relative usage of the bandwidth of the first communication channel 40 by the two feature-extraction task entities 11, 21 is controlled by a first bandwidth moderator 81 whilst the relative usage of the bandwidth of the second communication channel 41 by the two syntactic-analysis task entities 13, 23 is controlled by a second bandwidth moderator 82. It would be possible simply to have the first and second bandwidth moderators 81, 82 work independently, each operating as described for the moderator 70 of FIG. 2. Instead, however, provision is made for global coordination of the two moderators 81, 82 by a third, global, moderator 83. The role of the global moderator 83 is to guide the first and second moderators 81, 82 in making their determinations as to target relative usages by the different modalities. For example, the global moderator 83 may determine that whilst the first moderator 81 should favour the speech feature-extraction task entity 11 over the gesture feature-extraction task entity 21, the second moderator 82 should be more even-handed between the syntactic-analysis task entities 13, 23 of the two modalities. The first and second moderators 81, 82 make their final relative-usage determinations taking into account respective local activity (see arrows 90) in the task entities they control; the first and second moderators 81, 82 may also take account of the relative-usage determinations made by each other (see arrow 91).

Of course, a single, global, moderator could be used to directly control the relative usage of bandwidth for both the first and second channels 40, 41 without the use of the local first and second moderators 81, 82 described above.

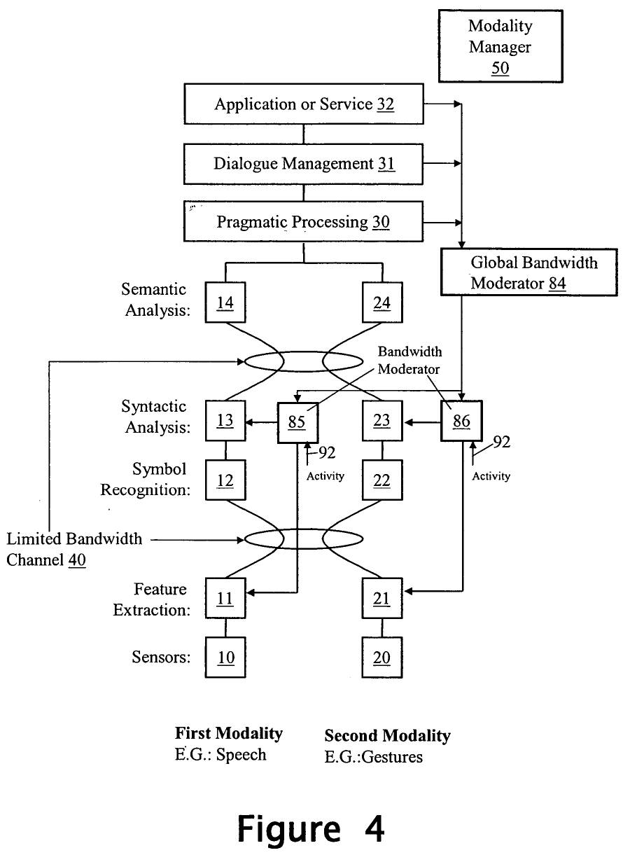

Instead of there being two separate communication channels 40, 41 at respective levels in the processing stacks of the two modalities, it may be that only a single channel is available both for communication between the feature-extraction task entities 11, 21 and the symbol-recognition task entities 12, 22 and for communication between the syntactic-analysis task entities 13, 23 and the semantic-analysis task entities 14, 24. In this case, the general configuration of moderators shown in FIG. 3 can still be employed with the global moderator 83 now determining, for example, the relative usage of bandwidth by the two processing-stack levels involved and the first and second moderators 81, 82 then each effecting a subordinate relative-usage determination between modalities at a respective one of these levels. An alternative arrangement of moderators is depicted in FIG. 4 where a global moderator 84 determines relative usage by modalities and each modality has an associated moderator 85, 86 respectively that effects a subordinate relative-usage determinations between the two concerned levels of the processing stack handling the modality, taking account of the activities at these levels (see arrows 92).

It will be appreciated that many variants are possible to the above described embodiments of the invention. For example, whilst the limited resource(s) controlled in the arrangements of FIGS. 3 and 4 is channel bandwidth, the controlled resources could alternatively be memory provided by a shared memory unit or processing power provided by a shared processing system.

With regard to the location of the moderators themselves, these can be located locally or remote from the task entities they control. However, at least notionally, the resource moderators can be considered as part of the modality manager 50 of the device. It may be noted that a resource moderator can be arranged to restrict resource access to zero for a particular modality in appropriate circumstances, thereby effectively eliminating that modality; preferably, however, the presence or absence of any particular modality is determined by higher-level functionality of the modality manager and the resource managers are arranged always to provide at least a minimum resource level to each modality that the higher-level functionality of the modality manager has decided should be present.

Whilst the particular task entity instances used in each modality processing stack can be predetermined or can be constituted by an ad hoc collection of available instances under the control of the modality manager, it is also possible to arrange for some or all of these entity instances to be predetermined (where all task entity instances are predetermined, the modality manager is not involved in organizing task entities to form viable modality processing stacks).

Although in the above described embodiments the control of the relative usage by different task entities of the limited resource is effected by controlling operation of the task entities concerned to vary their resource-usage needs, it will be appreciated that the control of the relative usage of the resource can effected in other ways such as by limiting data delivery to the resource from each task entity either by queuing the data or by selective culling of that data. The foregoing approaches to controlling relative usage by different task entities of the resource directly impact the actual usage of the resource by the task entities; however, it is also possible to effect a more indirect control by controlling the relative allocation of the resource between the task entities concerned. Thus, for example, where the resource is a communication channel using fixed duration time slots, during every unit period each task entity can be allocated a respective number of the time slots, the number of slots allocated to the different entities changing under the control of the bandwidth moderator as needed. Whether a time slot is actually used by the entity to which it has been allocated will depend on the immediate needs of the entity concerned; where that entity has no immediate need to use the time slot, it can be offered for use to another task entity.

It will be appreciated that, however effected, the above-described control of the relative usage by the task entities of the limited resource is concerned with controlling the relative average usage of the resource by the entities over a period of time; this is not to be confused with the switching of a resource from exclusive use by one entity to exclusive use by another entity as may be effected under the control of a low-level scheduler according to queued usage requests.

1. A method of dynamically controlling usage of a resource by task entities respectively involved in processing different input modalities, wherein the relative average actual or allocated usage of the resource by the task entities is dynamically adjusted according to one or more of the following:
actual usage of the different modalities by a user;
confidence in the results of processing of each of the modalities;
pragmatic information on mode usage.

2. A method according to claim 1, wherein the resource is communication bandwidth.

3. A method according to claim 1, wherein the resource is processing power.

4. A method according to claim 1, wherein the resource is memory.

5. A method according to claim 1 applied to each of two separate resources each used by different respective entities of said different input modalities, the adjustment of the relative usage by the different modalities of the two resources being independent of each other.

6. A method according to claim 1 applied to each of two separate resources each used by different respective entities of said different input modalities, the adjustment of the relative usage by the different modalities of the two resources being jointly controlled.

7. A method according to claim 1, wherein said resource is used by multiple task entities for each modality, the relative usage of the resource being first adjusted between modalities and then between task entities in the same modality.

8. A method according to claim 1, wherein said resource is used by multiple task entities for each modality, the relative usage of the resource being first adjusted between different groups of equivalent task entities of different modalities and then between task entities of the same group.

9. A method according to claim 1, wherein adjustment of the relative usage of the resource allocation is effected by one of:
controlling operation of the task entities to adjust their output to the resource;
controlling the flow of output from the task entities to the resource;
controlling the allocation of the resource between the task entities.

10. An arrangement comprising task entities respectively involved in processing different input modalities, a limited resource arranged to be used by the task entities, and a moderator for dynamically adjusting the relative average actual or allocated usage of the resource by the task entities in dependence on one or more of the following:
actual usage of the different modalities by a user;
confidence in the results of processing of each of the modalities;
pragmatic information on mode usage.

11. An arrangement according to claim 10, further comprising a respective additional task entity associated with each said input modality, and a communications system arranged to intercommunicate the task entities associated with the same input modality; said limited resource being communication bandwidth provided by said communications system.

12. An arrangement according to claim 10, wherein the task entities comprise a shared processing system and said limited resource is the processing power provided by this processing system.

13. An arrangement according to claim 10, wherein the task entities comprise a shared memory unit and said limited resource is the memory provided by the memory unit.

14. An arrangement according to claim 10, further comprising further task entities involved in processing respective ones of said input modalities, a further limited resource arranged to be used by said further task entities, and a further moderator for dynamically adjusting the relative average actual or allocated usage of the resource by the further task entities; the operation of the two moderators being independent of each other.

15. An arrangement according to claim 10, further comprising further task entities involved in processing respective ones of said input modalities, a further limited resource arranged to be used by said further task entities, and a further moderator for dynamically adjusting the relative average actual or allocated usage of the resource by the further task entities; the moderators being arranged to operate in a coordinated manner.

16. An arrangement according to claim 10, further comprising further task entities involved in processing respective ones of said input modalities, the further task entities also being arranged to use said resource and the moderator being arranged first to adjust relative usage of said resource between modalities and then between task entities in the same modality.

17. An arrangement according to claim 10, further comprising further task entities involved in processing respective ones of said input modalities, the further task entities also being arranged to use said resource and the moderator being arranged first to adjust relative usage of said resource between different groups of equivalent task entities of different modalities and then between task entities of the same group.

18. An arrangement according to claim 10, wherein the moderator is arranged to effect adjustment of the relative usage of the resource by one of:
controlling operation of the task entities to adjust their output to the resource;
controlling the flow of output from the task entities to the resource;
controlling the allocation of the resource between the task entities.
